(19) United States
(12) Patent Application Publication
(10) Pub. No.: US 2006/0214120 A1
(43) Pub. Date: Sep. 28, 2006

(54) Apparatus for shipping radioactive material

(76) Inventor: Roger C.P. Huang, Calabasas, CA (US)

Correspondence Address: HDSL, 4331 STEVENS BATTLE LANE, FAIRFAX, VA, 22033, US

(21) Appl. No.: 11/302,273

(22) Filed: Dec. 14, 2005

Related U.S. Application Data
(63) Continuation-in-part of application No. 10/984,455, filed on Nov. 10, 2004, now abandoned.

(51) Int. Cl. G21F 5/00

(52) U.S. Cl. 250/506.1

(57) ABSTRACT

A shipping apparatus for transporting radioactive material includes a bag body, a radioactive material container and a protective foam. The bag body has the top surface openable by a zip and a pair of lifting belts mounted on two sides, respectively. The supporting board is surrounded in the inner surface to form a bag volume inside the bag body and a pocket is removably attached on a predetermined location of the bag body. The protective foam can be fitted into the bag volume of the bag body with at least one room for receiving the radioactive material container holding the radioactive material.

### RELATED APPLICATIONS

This application is a continuation-in-part of U.S. patent application Ser. No. 10/984,455, filed on Nov. 10, 2004.

This application is related to U.S. patent application Ser. No. 10/768,101, filed on Feb. 2, 2004 now U.S. Pat. No. 6,812,475, entitled “Device For Storing Radioactive Material and Shipping Apparatus For The Same”, applied by the same inventor.

### BACKGROUND OF THE INVENTION

The present invention relates to an apparatus for shipping radioactive material, and more particular, to a radioactive material carrying bag incorporated with a radioactive material container both with protective ability for transporting radioactive material.

Radioactive material containers normally made by tusteng or lead or equivalent material are used to hold radioactive material. Conventionally, no specific shipping apparatus for transporting the radioactive material is provided. Moreover, the radioactive material containers are not incorporated with the radioactive material carrying bag to transport radioactive material to provide better protection.

### BRIEF SUMMARY OF THE INVENTION

Therefore, the present invention is to provide a shipping apparatus for safely and conveniently transporting radioactive material.

The shipping apparatus of the present invention includes a bag body, a supporting board, a pocket, a radioactive material container and a protective foam to provide safely and easily when transporting or delivering. The bag body has a lifting belt and one surface to be openable. The supporting board is surrounded in the inner surface of the bag body to form a bag volume inside the bag body. The pocket is attached on a predetermined location of the bag body for indicating the instruction of the carrying. The radioactive material container includes a lower cup portion, an upper cup portion which is securely engaged to the lower cup portion, and a chamber with a cushion member mounted in a top and a bottom end thereof, which is formed inside the container for storing the radioactive material to provide better protection when delivering. The protective foam is fitted into the bag volume, with at least one room for receiving the radioactive material container.

The objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These, as well as other features of the present invention, will become apparent upon reference to the drawings wherein:

FIG. 1 shows a perspective view of a shipping apparatus for transporting radioactive material according the present invention;

FIG. 2 shows the shipping apparatus in FIG. 1 with the top surface opened;

FIG. 3 shows a perspective view of a protective foam installed in the shipping apparatus according to one preferred embodiment;

FIG. 3A shows a perspective view of a protective foam installed in the shipping apparatus according to another preferred embodiment;

FIG. 4 shows a perspective exploded view of a radioactive material container;

FIGS. 4A to 4C shows different containers holding the radioactive material carried in the protective foam;

FIG. 5 shows another embodiment of a radioactive material shipping apparatus.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

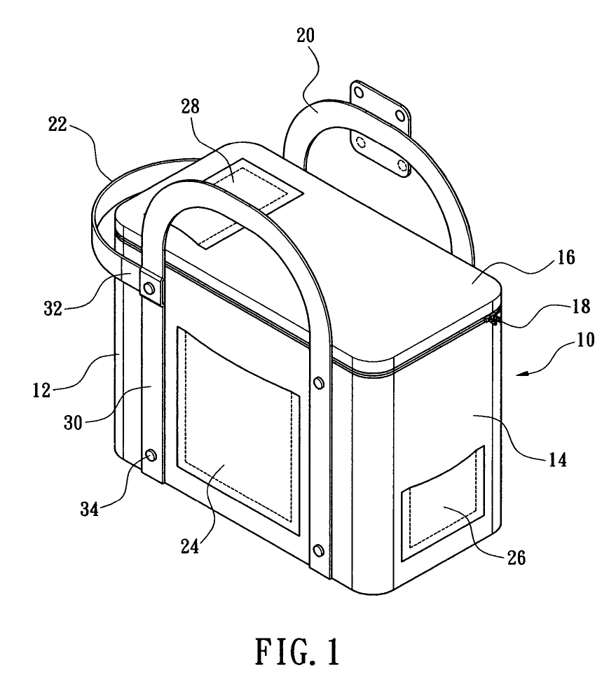

Referring to FIGS. 1 to 3, a shipping apparatus for transporting the radioactive material of the present includes a bag body 10, at least one protective foam 40 installed inside the bag body 10 and a radioactive material container 44 disposed in a receiving room 42 of the protective foam 40. The bag body 10 made of soft material, such as soft fiber, heavy Nylon, polyvinyl chloride (PVC) or other equivalent material, includes a belt 20, such as a pair of lifting belts 20 located on two respective sides, and/or a draw handle 22 furnished on the front for conveniently carrying. In order to strengthen the belt 20 and handle 22 secured on the bag body 10, an extending portion 30 or 32 corresponding to the belt 20 or the handle 22 is fixed on the side surface 12 of the bag body 10 by the pins 34. Moreover, a plurality of different types of pockets 24, 26 and 28 are attached, preferably removably attached on the bag body 10 by a Velcro or other equivalent ways such as push button. For example, two large pockets 24 may be attached on two side surfaces 12 of the bag body 10, respectively. Two small pockets 26 may be attached on the front and rear surface 14, respectively. One pocket 26 is attached on the top surface 16 of the bag body 10.

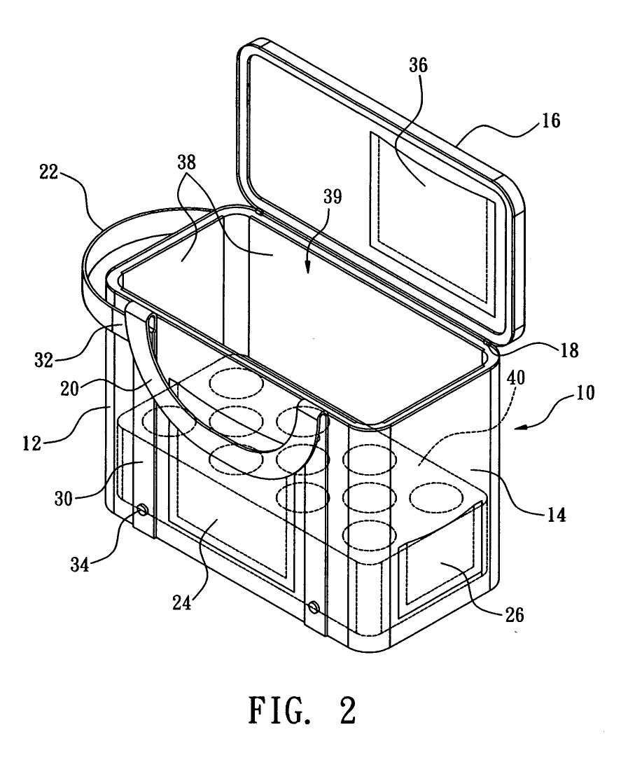

As shown in FIG. 2, the top surface 16 of the bag body 10 can be opened by a zip 18 or other equivalent ways to make the bag body 10 has one surface to be openable. Another medium pocket 38 may be attached on the inner side of the top surface 16. This and other pockets 24, 26, 28 and 36 can each be used to introduce a note card or others for showing information such as the information about the carrying radioactive material or other information related to the shipping apparatus. Because these pockets are preferably removably attached, it is conveniently to replace specific note easily. There is a support board 38 surrounded in the internal surface of the bag body 10 to create a bag volume 39 so that the protective foam 40 can be received therein. The support board 38 is made of plastic material such as PVC, polymer, wood, metal or other equivalent material.

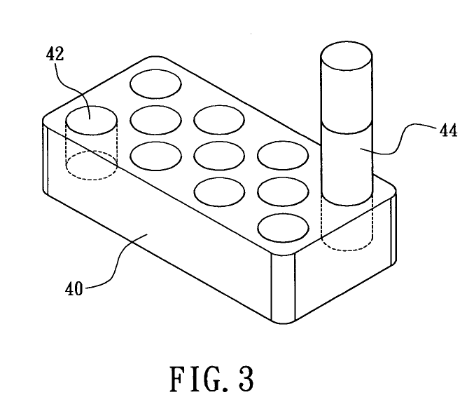

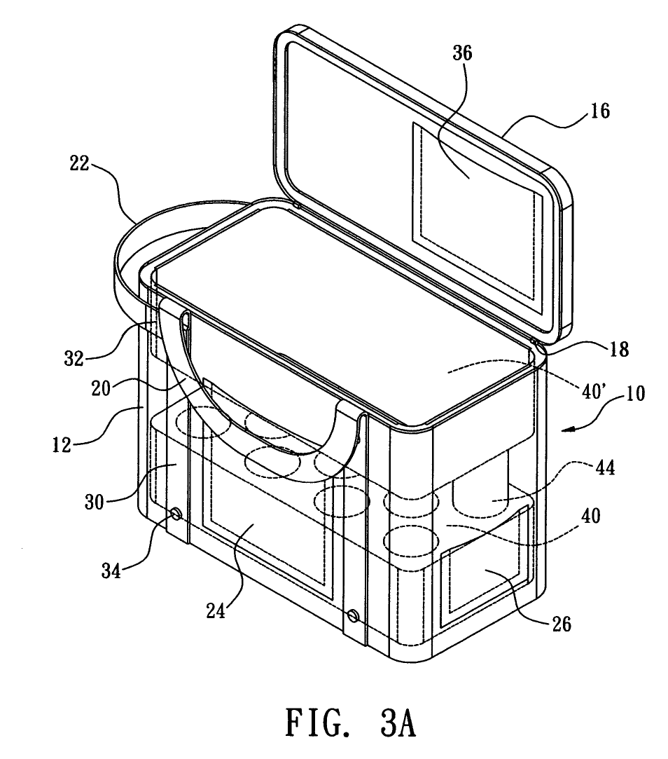

Please refer to FIG. 3, the protective foam 40 has a predetermined size to fit into the bag volume 30 inside the bag body 10. There can be two or more protective foams 40 stacked together to be put into the bag body 10. The protective foam 40 made of polymer, such as EVA foam, includes at least one room 42 for receiving the radioactive material container 44 holding the radioactive material 44. In another preferred embodiment, as shown in FIG. 3A, two protective foams 40 and 40′ are used to hold the radioactive material container 44.

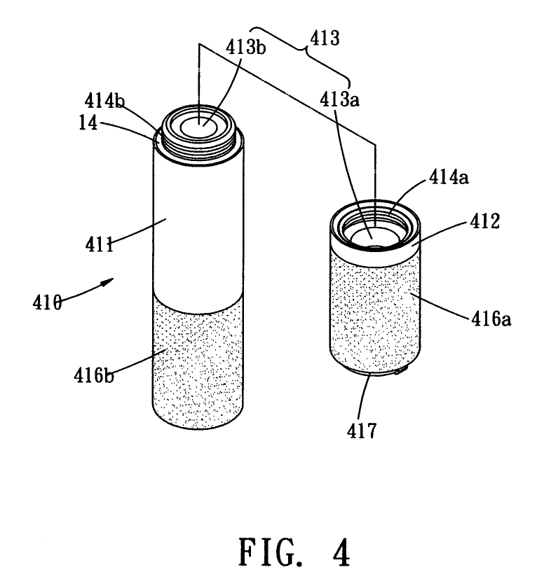

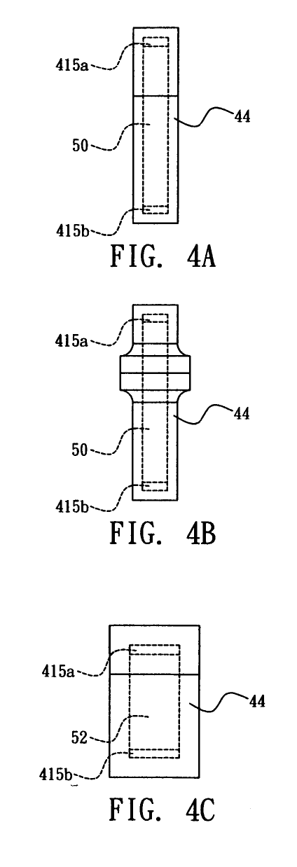

As shown in FIG. 4, the radioactive material container 44 includes a lower cup portion 411 and an upper cup portion 412 which can be securely engaged to the lower cup portion 411. Both the lower cup portion 411 and the upper cup portion 412 are preferably constructed of tungsten, but any radiation-resistant material such as lead maybe used. A chamber 413 is formed inside the radioactive material container 44 for storing radioactive material. In the preferred embodiment, the chamber 413 includes an upper and a lower internal cavities 413a and 413b formed in the upper cup portion 412 and the lower cup portion 411, respectively, which is formed while the radioactive material container 44 is assembled by connecting the upper cup portion 412 to the lower cup portion 411. The chamber 413 can be syringe-like to receive a syringe holding the radioactive material.

In order to conveniently grasp and combine the upper cup portion 412 and the lower cup potion 411, a roughened surface 416a and 416b, such as made of polymer such as ABS or other equivalent material, are formed on a surface thereof, respectively. The lower cup portion 411 has a threaded area 414b on the external surface of the open end of the lower cavity 413b. On the other hand, the upper cup portion 412 has a threads 414a on the internal surface of the open end of the upper cavity 413a configured to engage the threads of the threaded area 414b of the lower cavity 413b on the lower cup portion 411. Moreover, an O-ring 414 fits between the lower cup portion 411 and the upper cup portion 412 to provide an air and fluid tight seal. Meanwhile, there are cushion members 415a and 415b (as shown in FIGS. 4A, 4B and 4C) mounted in both ends of the chamber 413, respectively, that is, the cushion member 415a is mounted in the closed end of the upper cavity 413a, and a cushion member 415b is mounted in the closed end of the lower cavity 413b. The cushion member 415a and 415b can be a sponge to reduce the shock and collision when the radioactive material container 44 is transported.

The radioactive material container 44 can be different kind of radioactive material container such as illustrated in FIG. 4A, 4B or 4C. In FIGS. 4A and 4B, the radioactive material container 44 may hold a syringe or a vial 50 containing the stronger radioactive material. In FIG. 4C, the radioactive material container 44 may directly hold radioactive medicine 52.

In another preferred embodiments, the thread engagement between the cup portions can be changed to other locking mechanism such as a quick lock engagement or a spring quick lock engagement in the conventional art.

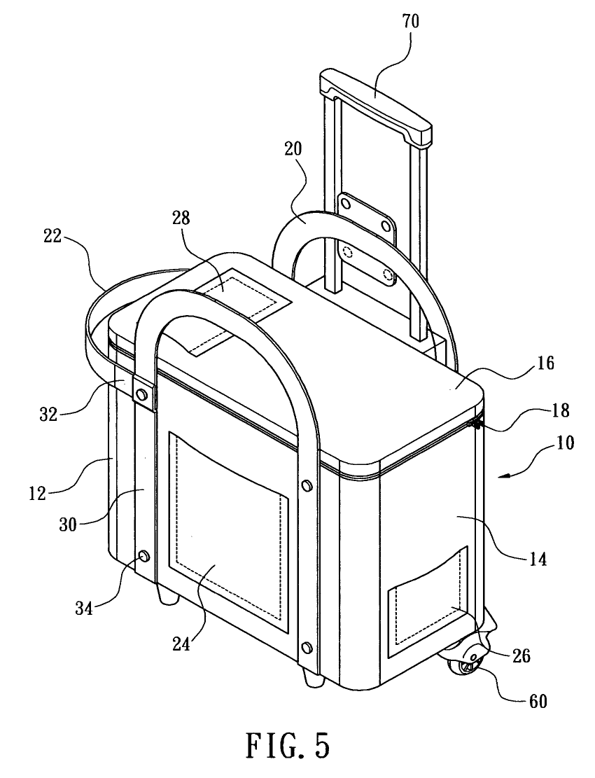

As shown in FIG. 5, the bag body 10 of the shipping apparatus according to another embodiment of the present invention includes a retractable handle 70 extended upwardly from the bag body 10 to safely deliver the radioactive material. There are a plurality of wheels 60 mounted under the bag body 10 for convenient conveyance.

This disclosure provides exemplary embodiments of the present invention. The scope of this disclosure is not limited by these exemplary embodiments. Numerous variations, whether explicitly provided for by the specification or implied by the specification, such as variations in shape, structure, dimension, type of material or manufacturing process may be implemented by one of skill in the art in view of this disclosure.

I claim:

1. A shipping apparatus for transporting radioactive material, comprising:
a bag body;
a supporting board surrounded in the inner surface of the bag body to form a bag volume inside the bag body;
a radioactive material container including a lower cup portion, an upper cup portion which is securely engaged to the lower cup portion, and a chamber with a cushion member mounted in a top and a bottom end thereof, which is formed inside the container for storing the radioactive material; and
a protective foam fitted into the bag volume, with at least one room for receiving the radioactive material container.

2. The apparatus of claim 1, wherein the bag body has a lifting belt and a top surface to be openable.

3. The apparatus of claim 2, wherein the bag body has a pair of lifting belts mounted on two sides, respectively.

4. The apparatus of claim 2, further comprising a pulling handle mounted the bag body.

5. The apparatus of claim 1, wherein the bag body is made of soft material.

6. The apparatus of claim 5, wherein the bag body is made of heavy Nylon.

7. The apparatus of claim 5, wherein bag body is made of polymer.

8. The apparatus of claim 1, wherein the bag body is made of soft fiber.

9. The apparatus of claim 1, wherein the supporting board is a polyvinyl chloride (PVC) board, a polymer board, a wood board or a metal board.

10. The apparatus of claim 1, wherein the protective foam is made of polymer.

11. The apparatus of claim 10, wherein the protective foam is EVA foam.

12. The apparatus of claim 1, further comprising a pocket attached on a predetermined location of the bag body;

13. The apparatus of claim 12, wherein the pocket is movably attached on the inner side of the top surface.

14. The apparatus of claim 1, further comprising a plurality of wheels mounted under the bag body, and a retractable handle extended upwardly from the bag body.

15. The apparatus of claim 1, wherein the radioactive material container holds a syringe containing radioactive medicine.

16. The apparatus of claim 1, wherein the radioactive material container holds a vial containing radioactive medicine.

17. The apparatus of claim 1, wherein the container directly holds radioactive medicine.

18. The apparatus of claim 1, further comprising two protective foams stacked together to be fittedly put into the bag volume of the bag body.

19. The apparatus of claim 1, wherein the chamber is formed by combining an upper and a lower internal cavities of the upper and the lower cup portions, respectively.

20. The apparatus of claim 1, wherein the upper cup portion includes a threads configured to engage the threads of a threaded area of the lower cup portion, and an O-ring fits between the lower and the upper cup portions.
